(19) United States
(12) Patent Application Publication
(10) Pub. No.: US 2006/0185615 A1
(43) Pub. Date: Aug. 24, 2006

(54) ANIMAL / HUMAN MASSAGE, GENTLING, GROOMING, TACTILE-DIAGNOSTIC TOOL A Multi-Use / Multi-Functional Tool

(75) Inventor: David B. Gorin, French Creek, WV (US)

Correspondence Address: DAVID B. GORIN, RT. 1 BOX 28, FRENCH CREEK, WV, 26218, US

(73) Assignee: David B. Gorin, French Creek, WV (US)

(21) Appl. No.: 11/307,720

(22) Filed: Feb. 17, 2006

Related U.S. Application Data
(60) Provisional application No. 60/593,870, filed on Feb. 19, 2005.

(51) Int. Cl. A01K 13/00

(52) U.S. Cl. 119/600

(57) ABSTRACT

What is provided is a device and method for gentling equine, other animals, and in some cases a human of which is obtained through the actions of massage, grooming and pole-gentling methodologies and protocols in which it is thoroughly and effectively enabled by an apparatus comprised of three essential hand-tool components: the elongated extension-pole control handle, the cylindrical nodulated massage/gentler tool-head attachment shaft that emits auto-mechanical vibration stimulus, and the cylindrical cone-shaped bristle covered massage/gentler, groomer, exfoliator, tool-head attachment shaft which provides dander exfoliation, body and leg stimulus. Used regularly in succession or independently, animal gentling, animal health and core relationship foundations can be achieved and maintained. The present invention provides a more practical, convenient, ergonomic, physical and psychological stress-reduction, and safer method and means to care for and manage feral and domesticated animals, and in some instances in use of massage therapy on humans.

### BACKGROUND OF THE INVENTION

The inventor of this present invention has extensive knowledge and experience in animal husbandry and massage therapy, particularly in the equine-training, gentling, care, management and hoof-care fields. Although the present invention generally relates to animal care and wellness for domesticated animals, zoological animals, livestock, and humans, the inventor's primary focus of his invention is generally targeted toward use on the equine species and matters regarding massage, gentling/bonding and grooming. Therefore, to make the background of the present invention easier to understand and to build a strong case on its behalf, the inventor will be referring generally to the equine or “the horse” as the main subject or target of use in correlation to the system, operation, function and design of the present invention within this subject.

Horses are dangerous animals because of their size, strength, and their nervous nature, and they can potentially harm themselves or injure, maim or even kill people or handlers around them. Much attention goes into the gentling and taming of such an animal to significantly lessen the chance of harm to the handlers and the equine themselves. Horses generally are very intolerant of pain; hence they are very receptive to kindness, tender touching and easy handling. Sophisticated, intellectual techniques, methodologies and protocols are commonly practiced when bonding, gentling and maintaining equine health and camaraderie. This is to clarify that this form of animal care is extremely important and essential in acquiring and maintaining a safer, healthier animal/human working relationship.

Horses are a cherished, respected, and well-loved animal used today and by people throughout history. They are useful, complex animals of beauty, grace, athleticism and courage; also they are generally quick-learners and easy to train. For these reasons equine are desired for many categories of use: such as pleasure riding, show, dressage, racing, rodeo, carriage, farm work, et cetera. The demands on horses to perform in some instances are very extreme and caretakers often do all they can to promote that horse to exhibit peak performance and well-being. Horses are generally high-maintenance animals if an owner or caretaker wants reasonable performance and general good health from the animal. Several actions are performed or provided to take care of such an animal, i.e., a nutritional, well-balanced feeding regime; adequate pasture and shelter; grooming and bathing; equine massage therapy; routine gentling; veterinarian care; ground training and other more specific training for the animal's intended or preferred line of work or duty.

Massage and touch gentling are a common and powerful means of bonding with an animal gaining their attention, trust and friendship which provides a happier, safer working relationship. Often gentling processes and protocols are performed on wild horses or on equine that are nervous, shy or untamed. Even horses that have been well-trained and exhibit good manners need constant reassurance and guidance on a regular basis to maintain a calm well-mannered, manageable horse.

The present invention pertains to a new, unique, impressionable, effective method and means of massage and gentling an animal. There is an ever-growing public awareness in these fields that “touch” or tactile-gentling is a quick, easy, effective and humane method to gain trust and friendship from the equine. The present invention lends itself to becoming an epic tool used in these fields.

One of the main factors in caring for the horse is hoof-care, such as trimming and shoeing, which is not only expensive to the equine owners and dangerous to perform, but also physically complicated to achieve by the farrier or hoof-care giver; hence the popular phrase among horsemen “no hoof, no horse”. Therefore, much time and effort go into acclimating a horse's limbs to touch and handling. Consequently, the horses will allow thorough hoof-care treatment with the least amount of struggle or danger to all involved. The present invention is a novel tool/system that fulfills this need to safely, easily, and effectively acclimate the equine's leg parts to touch and handling.

There are and have been many devices and products, prior art available related to equine care and management fields that pertain to the present invention. For instance: the human hand, small hand-held massage tools, vibrators, bamboo or lightweight animal gentling poles, bathing scrubbers, brush and comb grooming tools. These tools are well-known in the arts of equine massage, grooming, care, and training. These tools provide fair performance and results for the user, and must be used individually and within close contact to the equine and also puts the user in awkward, uncomfortable crouching positions that are stressful on the user's body, and also puts the user in danger from being crowded, kicked or stepped on. These tools are not as safe, practical or multi-functional as the present invention is, nor do they provide the auto-mechanical vibrations that mimic the feel of a “mother mare licking and nudging her foal” what she instinctively does to gain and maintain a strong bond through caring reassurance and guidance. One of the key characteristics of the present invention is its capabilities to mimic or simulate tender “licking” and “nudging” sensations by means of sensuous auto-mechanical vibrations when used in a gentle, lateral back and forth, reciprocating and caressing motion.

The present invention provides a new and unique method and means to strategically and intellectually administer tactile care and treatment by means of targeting the acupressure points, reflex points, neurological meridians, muscle trigger points, sore or stiff muscles and tendons of the animal or human; all of which can be learned and is practiced by people of average intelligence, skill and experience. Much potential use of the present invention will be at animal hospitals and clinics.

In regards to the prior art of grooming tools, such as brushes, combs, and curry combs, these are obvious, well-known tools of the trade, even since the time animals were becoming domesticated. The present invention is unique in the fact that it also provides grooming capabilities and characteristic of such common grooming utensils, and yet has the extra capability of thoroughly exfoliating the thick skin of some animals, most notably “the horse”. Another uniquely effective feature of the present invention is that it provides the user a means to thoroughly scrub and exfoliate heavy or thick layers of mud and debris from the equine's fur coat. This is extremely helpful when there is no time or conveniences to otherwise perform a more thorough cleaning.

As far as tactile diagnostic tools are concerned relating to prior art, there is the small rubber-tipped hammer that doctors use on people to check for reflex reactions which is well known as a common physician's tool. Usually tactile diagnostics are performed by hands-on techniques, i.e. pressing or touching areas of an animal's body to determine soreness, stiffness, tenderness, thorns, or small puncture wounds. The present invention offers a new method and means to check, examine these types of ailments; most particularly of animals that are sick, in shock, frightened or incumbent.

The present invention, more specifically tool-head attachment-A, provides an “auto-mechanical vibration” massage that is produced when in use via a lateral “back and forth” or reciprocating motion, which when is caressed over a human or animal's body in a reciprocating back-and-forth motion, the said nodules lightly bounce on-and-off the body surface of the subject being, producing auto-mechanical vibrations which are soothing, calming, relaxing and which mimic or simulate the feel, impression, or touch of a mother mare licking and nudging her newborn foal; and does not have or need any form of electric power to operate. Any prior art information on this aspect of the present invention is in that of other commonly known manual or electric-powered body massage devices, in which none of these tools perform as uniquely strategic, specific, practical, convenient, or as effective as does the present invention.

Mare bonding with her newborn foal: Within the first moments after a foal is born, the mother mare licks and lightly nudges and sniffs her new baby, mostly around the head regions. The head regions have major neurological pleasure receptors that release chemicals or endorphins throughout the foal's or animal's body when touched or pressed upon in a gentle, tender manner. This action causes the foal to relax, trust and bond with its mother, in which she repeats these tender actions of comfort on a daily basis and this action dissipates on toward weaning time. This action commonly known as “bond imprinting” creates a strong, trusting and caring bond between the two, as it does in most mammals. Therefore, the young foal will now stay close by mother, relying on her reassurance, protection and guidance throughout its adolescent life. A strong feature/quality of the present invention when in use is the ability to auto-mechanically and effectively mimic or stimulate the feel and sensation of licking, much like that of a mother mare licking her baby, this is especially effective and beneficial on adult horses, shy/nervous horses, feral horses etc, who need the constant reassurance of trust and comfort with humans.

When a human is petting, stroking or massaging a young or mature horse he/she is basically doing the same physical bonding that the mare was doing to her newborn foal but with much more forethought and more dynamic, strategic, sophisticated precision, even from a novice handler. The human is manually manipulating pleasure receptors within the horse which relaxes the nerves and gives the horse a sense of well-being that inevitably nurtures a strong, trusting bond between the animal and handler. These actions are repeated often on an animal to gain and maintain the animal's attention, trust, and positive working relationship. The present invention can perform these types of tactile bonding regimes in many instances in an easier, safer, sophisticated, intellectual manner than what the motherly mare can provide or even in some instances what the human hand can provide.

In prior art, the human hand is usually the means that is used to perform massage/gentling. This is acceptable, but it limits the handler to fewer tactile options while also putting them in close physical contact with the animal and it can obviously be dangerous to them when working on large, tall, powerful, extra nervous or shy animals. The present invention can perform these types of massage, or tactile-bonding regimes, in many instances in an easier, safer, sophisticated manner with hyper-effective results.

The present invention combines all of the aforementioned tools into one. While providing the user the ability to maintain a safer distance from a potentially dangerous animal, the present invention also allows the user to maintain an upright position which is significantly less stressful on the user's body, most particularly the lower back. The present invention also allows the user to visually monitor and observe the animal's entire body movements and also any outward expressions of calm or distress. Likewise the animal will feel more at ease when he can see what the handler is doing, which encourages the animal to stand still and relaxed for care, handling, hoof maintenance and training.

Human use: During research and development of the present invention, significant positive evidence has been observed by the inventor in which that humans (trial participants) have expressed their pronounced delight in regards to using and operating the massage-head feature of the present invention on another person, and on having it used on them. This is not to say that other prior art of this nature is completely insignificant, but it is to say and express that the present invention is a major advancement in equine and human massage and gentling methodologies, techniques, therapies and systems and as an inspiration to animal/human relationships.

It has also been witnessed and observed that humans are very excited, eager, and obliged when using the present invention on a horse or other subject animals. Also trail participants have expressed that “not only using the said tool was a true pleasure but that it also provided them with a emotional since of well-being and productive positive energy toward their subject horse,” all of which is an inspiration for users to spend more quality, constructive time with their animals.

Ideally, it would be more efficient and practical, and possibly economical, for such a device as the present invention to be comprised of only one tool-head attachment. For example, a tool-head attachment that manually converts from a nodulated massage gentler adapter to a groomer/exfoliator adapter at the twist or the click of a switch. Yet, this type of mechanical configuration would be extremely complicated and technical to devise and would be much more expensive to manufacture and produce; hence, more expensive for the consumer to purchase. Furthermore, such a bi-unitary convertible device would inevitably have nooks and crannies, seams, holes, and pits that would harbor dander and germs, making it impossible to thoroughly clean and disinfect. Also, any said nooks and crannies would snag and pinch skin and hair/fur of an animal or human causing extreme physical pain. Therefore, it is much more feasible and practical to comprise the present invention of two separate solid-form tool-head adapters to eliminate any mechanical complications, pinch hazards, and cleaning/disinfecting difficulties. Therefore, the present invention is soundly feasible and practical in all its features and functions as two separate tool-head attachments to allow proper form and function.

POLE GENTLING and how this act directly relates to the present invention:

The gentling pole or “g-pole” is the tool used in the action of pole gentling an equine. Pole gentling is the act of and form of taming an equine or animal, by means of touch, using a simple tool commonly known as a gentling pole: a long, straight, generally light-weight pole made of bamboo or pine wood which generally measures 5 to 12 to 20 feet in length generally, by 1½ inches in diameter generally. Some handlers may tie a rag or a short piece of rope to the tip of the pole as an added article to desensitize the untamed animal. The general techniques of pole-gentling are to herd a feral “wild horse” or a domestic horse that is fearful of human contact and secure it into a field, pasture, small corral or round pen. The handler positions himself in the center of the pen and then begins to gently pursue the horse with the g-pole extended outwardly toward the subject as if to say “I just want to touch you . . . not hurt you” i.e. present it to the horse as an offering . . . not as a forceful threat. The horse, in an attempt to flee, circles and pauses around the handler. It is the trainer's objective to keep the horse's panic level to a bare minimum to allow the horse to mentally digest and acclimate to new conditions, accept the human's close proximity and ultimately bond with the trainer, human. Eventually the horse will become a bit tired and a little more accustomed to the g-pole at which time the horse will slow down and come to a stop, and cautiously let the handler touch and caress the least sensitive parts of its body, which usually is under the neck and shoulder areas. After the horse becomes thoroughly acclimated to the pole, the handler can then start to slowly rub on some of the trigger points to further gentle the beast and then get closer to the animal while still rubbing the end of the pole on the body. Eventually the handler will be close enough to the horse so that he can put his hands on it and switch to hand-gentling. Now the handler has the opportunity to strategically target the trigger and pressure points of the animal's head and facial regions. This activates positive physical and neurological responses from the horse. Immediately the animal becomes even calmer, which in effect promotes a quicker trust and bond with the handler. At this point, the horse and handler are well on their way to securing a caring, trusting relationship. This form of touch gentling and bonding is the start of a core-relationship foundation or the human/animal relationship sanctuary.

The present invention has a strong potential to play an integral role within pole-gentling techniques and protocols; most particularly, after the horse becomes accustomed to the touch of the gentling pole and/or the touch of the human hand. Also the present invention becomes a staple of use throughout the animal's life in maintaining trusting relationships, physical health and a sense of well-being between animal and human.

Within this description of general protocols of use on a shy or inexperienced horse, the present invention is descried and referred to as “the tool”. Using the present invention on a horse is as follows:

(1) First show and offer the tool to the subject horse and let him sniff and fondle the tool with its lips and muzzle parts. Be careful to not let him bite the tool. The horse will acquaint himself with the tool by using its five senses: sight, sound, smell, taste or lick, and touch.

(2) After the horse becomes “muzzle-acquainted” with the tool you can now work your way on back over the rest of the body. To begin, disconnect the extension pole handle, and use only the tool-head-A or -B alone. Then begin rubbing the end-knob on the side of the horse's muzzle, and then work your way on back to the large jaw muscle, then up to base of ear then on to the small-of-neck regions. Work back along these first areas and then repeat these processes on the opposite side of the horse.

(3) Now start working on regions of the neck, from the small-of-neck to the base-of-neck, then onto the withers and shoulder muscles. At this point you can do some “touching” on the upper-front-leg-parts, lighter touch along ribcage and onto the spinal/back and rump muscles, then onto the upper muscled rear leg parts. Repeat these processes on the opposite side of the horse. Note: At this time one may choose to use the tool with the extension-pole handle fastened to either one of the tool-head adaptors.

(4) Once the horse has become comfortable with the tool's touch, you can now start working on the lower leg regions by using the tool head attachment-B featuring the exfoliator cone-spikes. Horses usually are a little extra sensitive or touchy around the legs and feet areas, so it is a good idea to take your time and gradually acclimate the legs to being touched and handled. Always repeat these processes on the opposite side of the horse. Using commonly known “rope gentling” techniques to help with gentling leg and body parts is a very important addition to your methods when acclimating horses to touch and handling.

Protocols of massage, use on humans pertaining to the tool-head-attachment-A:

With the subject person lying or sitting, the operator can use the tool with or without the extension-pole handle. The action is relatively simple, for instance one can be sitting and typing on their PC while the operator gently glides the tool over subject's neck, shoulders, back, and legs, etc. Also one can lay out flat on a bed, where as the operator can do more thorough body massage on their subject's entire body using lateral and horizontal motions and inline direct pressure.

### SUMMARY OF THE INVENTION

The present invention provides several designated tasks in one tool: (1) Animal gentling/pole-gentling. (2) Equine leg and hoof acclimation to touch and handling. (3) Animal/human massage. (4) Grooming/skin, dander and hair exfoliation. (5) Animal body surface observation: tactile diagnosis.

The present invention is comprised of three main tool parts or components that enable, allow, facilitate and provide the tool to fully function and operate at peak capacity and performance levels and is considered by the inventor as an animal/human care system. The three components are:
(1) The, cylindrical, streamlined nodular massage tool head with gauging neck and spherical knob tip with built-in grip fastener base-end as one solid tool-head unit adaptor.
(2) The cylindrical, streamlined cone shaped spikes/bristled massage-exfoliator brush tool head with built-in grip fastener base-end as one solid tool-head unit adaptor.
(3) The elongated extension-pole handle with built-in grip-fastener at the working end to facilitate the secure connection of the two said tool-head adaptors, attachments and the interchangeability of the said adaptors.

The present invention's two separate working tool-head-ends perform in unison to complete the system of operation, functions, purpose and the user's specific objectives at any given time, i.e. for the user to thoroughly and completely achieve these specific tasks of treating an animal from head to toe, it is imperative that the user utilize one tool-head and then switch to the other-tool head or visa-versa to accomplish their desired objectives and to obtain results that the present invention provides. The elongated extension-pole-control-handle provides the user to maintain safer and better observational body positioning while also providing the user with a greater range of mobility, reach, and strategic maneuvering around the body of equine, human, or zoological animals.

Tool-head-attachment-A regarding massage and gentling an equine is used mainly on the muscled parts of the body, base of ear and jaw-line. Tool-head-attachment-B is also used on the muscled parts of the body but its use is also specifically targeted for the more highly sensitive leg parts which are comprised of dense fur, thick skin, bone, cartilage, sinew, and narrow nooks and crannies; for this reason tool-head-attachment-B featuring its elongated cluster of spiked-cone bristles has a more specific function in this case to provide a lighter, more gentle, more soothing touch to the leg regions of which tool-head attachment-A can not provide. Horse's boney legs have thick skin and dense, sometimes coarse fur. These leg parts are often itchy and irritated from fly bites, thorns, dander, gritty soil, dust and infectious microbes. Often one can observe a horse biting at his legs and pastern in attempts to scratch an itch. This is where a handler can take full advantage of gentling the equine legs or “make friends with” the lower leg parts. By gently dry or wet scrubbing the leg regions in a grooming manner, a handler can rapidly and with profound effectiveness acclimate these specific leg regions, something that needs to be done intermittently as body acclimation reinforcement. While also on this subject, it is a fact that normally in the equine care/management fields, scrubbing and thoroughly cleansing a horse's leg part can be a daunting, difficult, even dangerous task. As is the common case: the handler is crouched and hunkered down and around the animal's legs and body physically reaching between the horse's legs/hooves with their arms and scrubber/hand tool; a job that is extremely awkward, cumbersome and can cause severe body pain, muscle stiffness and discomfort to the groom/handler. Also the handler is in a dangerous position where he/she can potentially get kicked or stepped upon by the horse. The present invention provides a much more practical, more comfortable, more convenient, more effective and even safer method and means to do these said tasks. Comparatively to the present invention, no other tool has been observed or found by the present inventor that can acclimate-to-touch, groom and manipulate the equine leg parts with such ease and effectiveness as does the present invention. The present invention is revolutionary in these regards.

Note: The elongated extension-pole-control-handle (FIG. 3-A)-(10) is not claimed by the inventor to be an invention of his own, but is only described in these documents as reference to the elongated extension-pole-control-handle as being a significant, necessary, integral part of the present invention's system, design, function, operation and purpose.

### OBJECTIVES

It is the objective of the present invention to provide a method and means of which is an animal gentling and care tool-use system that of which is used systematically and in accordance with the nature of the subject animal's humanization, tameness, and temperament.

It is the objective of the present invention to provide the user with a physically easier method and means of massaging an animal or human.

It is the objective of the present invention to provide the user with a physically easier method and means of gentling an animal.

It is the objective of the present invention to provide the user with a physically easier method and means of desensitizing an animal: acclimating the animal to touch.

It is the objective of the present invention to provide the user with a physically and visually easier, safer method and means of examination and observation of an animal.

It is the objective of the present invention to provide a method and means to administer auto-mechanical massage vibrations by means of manually induced shockwave stimuli on an animal's or human's body.

It is the objective of the present invention to provide a safer means of massaging an animal, such as a notoriously dangerous animal, such as the equine leg parts that potentially put the user at risk from kicking, striking, or being stepped on by the animal.

It is the objective of the present invention to provide a safer method and means of gentling an animal, such as a notoriously dangerous animal and such as the equine leg parts that potentially put the user at risk from kicking, striking, or being stepped on by the animal.

It is the objective of the present invention to provide a safer method and means of desensitizing an animal, such as a notoriously dangerous animal and such as the equine leg parts that potentially put the user at risk from kicking, striking, or being stepped on by the animal.

It is the objective of the present invention to provide a safer method and means of examining an animal, such as a notoriously dangerous animal, and such as the equine leg parts that potentially put the user at risk from kicking, striking, or being stepped on by the animal.

It is the objective of the present invention to provide a practical method and means to groom or comb the animal's coat while simultaneously providing massage to the animal.

It is the objective of the present invention to provide the user to place themselves at a safer distance from the animal so as to enable the user to maintain better visual assessment of the animal for any mental or physical response or actions.

It is the objective of the present invention to provide the user a method and means to administer various methods and techniques, massage, gentling and body treatments.

It is the objective of the present invention to acclimate an animal's leg to touch, allowing the user to perform hoof-care, handling and treatment.

It is the objective of the present invention to provide and promote the animal with a sense of mental and physical well-being.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1A: Tool-head-attachment-A: Total main body view of circumferentially circular, streamlined cylindrical nodular shaft used for massage/gentling, and tactile diagnoses.

FIG. 2A: Tool-head-attachment-B: Total main body view of circumferentially circular, streamlined cylindrical spiked shaft used for massage/gentling animal leg and hoof acclimation, grooming, and tactile diagnoses.

FIG. 3A: View of both tool-head-attachments-A and -B affixed to the elongated extension-pole-control-handle (10) by any suitable means of secure fastening (11) expressing the present inventions complete, total form.

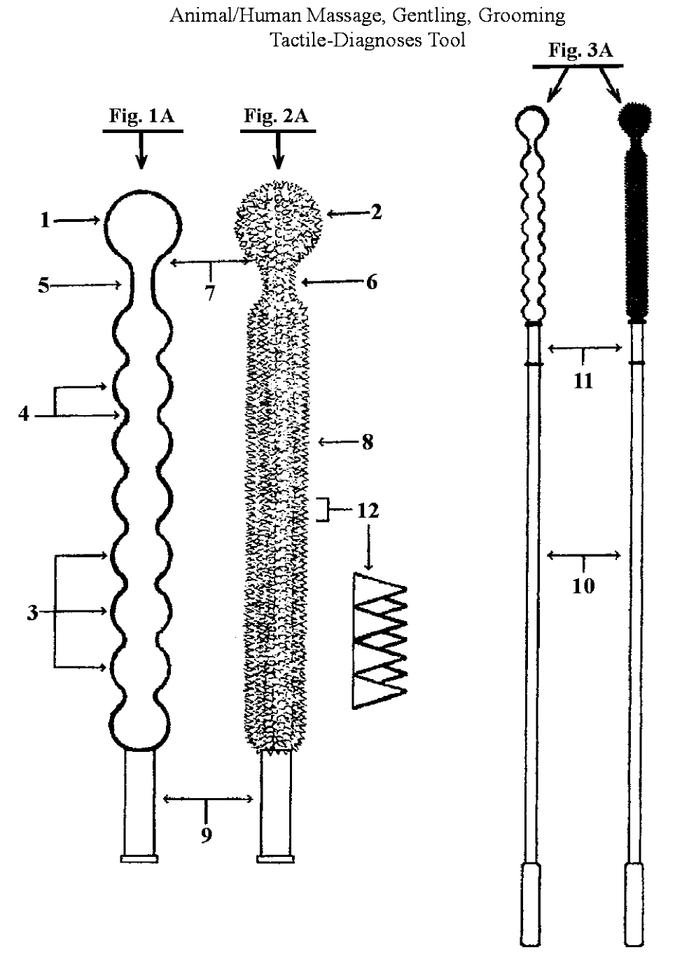

FIG. 1A: Enlarged spherical head-knob, (1)

FIG. 2A: Enlarged, spiked spherical head-knob, (2)

FIG. 1A: Shows the lengthily in-line series of independent spherical nodules (3) in a single row that form the said cylindrical main body of tool-head-attachment-A

FIG. 1A: Indication that the diameter of the narrow intervals (4) are generally one half the diameters of the said in-line series of nodules fixed or positioned at equal and uniform distances from each other.

FIG. 1A: Narrow, elongated gauging neck (5) of tool-head-attachment-A.

FIG. 2A: Narrow, elongated, spiked gauging neck (6) of tool-head-attachment-B.

FIG. 1A X 2A: The “pulling-nook” (7) of both tool-head-attachments-A and -B.

FIG. 2A: Pattern of cone-shaped spikes in a series of staggered rows (8) which cover the entire surface area of tool-head-attachment-B

FIG. 1A X 2A: Both hand-operated tool-head-fasteners (9) of the tool-head-attachments-A and -B to provide any suitable means of secure fastening of the said extension-pole operating handle.

FIG. 2A: A close-up view showing several cone shaped spikes (12).

### DETAILED DESCRIPTION OF PREFERRED EMBODIMENTS

The present invention is a multi-use, multi-functional, hand-held, hand-operated tool that is for the use in the equine/human massage therapy, pole-gentling, animal husbandry, and equine care/management fields. Aspects of the present invention can be used on the human body as well. The present invention is generally easy to use and to operate and has a high value of need and usefulness. The present invention can be used throughout the large spectrum of equine, animal husbandry, and human wellness fields, commercially and non-commercially, and within the private sector and also within business organizations or institutions. The foremost objectives or uses of the present invention are for administration of animal or equine massage therapy, animal gentling/taming, grooming/bathing, skin exfoliation, tactile examinations and diagnosis. The present invention potentially will be used by equine massage therapists/schools, human massage therapists/schools, veterinarians, veterinary hospitals/universities, farriers and hoof-care specialists, ranchers, farmers, breeders, zoos and zoologists, equine racing trainers, handlers, and caretakers, the average person, even animal rescue personnel.

The present invention provides an auto-mechanical vibration massage that is produced when in use via a lengthwise back and forth or reciprocating motion. To be more specific, as the succession of nodules are pressed against and over a body part, most particularly smaller protruding body parts, impact of the said nodules in rapid succession emit physical shockwaves that penetrate the muscles and body tissue that are pleasantly stimulating, relaxing and soothing to the subject's body. Faster length-wise reciprocating motion will emit more intense shockwave value or vibration; adversely slower reciprocating motions will emit milder shockwave values; in respect, less or more pressure applied to the body also has an effect on the shockwave intensity, hence the term “auto-mechanical vibration”.

To enable the present invention to be durable and exhibit high resistance to wear or longevity, and also to function and operate proper performance both tool-head-attachments are made of a high-performance, durable, impact-resistant, scratch-resistant thermoplastic material, such as polyurethane. The tool-head-attachments-A and -B, or working-end surfaces, are as smooth as glass to provide and allow the tool to slide or glide across a human's skin and/or through or over an animal's fur coat without pulling on the fur or pinch the skin, which normally is physically irritating to the animal. The tool heads are easy to clean and disinfect as they have no small crevasses or nooks and crannies that can hide or trap debris, bacteria or disease.

All parts of the present invention are cold, heat, and chemical-resistant because such a tool potentially will be used in a diversity of weather conditions and also in germ or disease-infected areas. Also it may be used on animals knowingly or unknowingly that are diseased. It is advised that the tool will be washed, disinfected between each use by means of chemical detergents, disinfectants and/or hot water to prevent contamination or spread of disease.

The present invention consists of two working-end tool-head-attachments FIG. 1-A, FIG. 2-A, and an elongated extension-pole control handle, FIG. 3-A, that facilitates the two said tool-end-attachments. Both said tool-head-attachments-A and -B are interchangeable by means of a secure hand-operated “hand-grip-fastener” (9).

Ideally both tool-head-attachments are constructed or made by an injection mold process by means of a steel cast or master mold that produces a performance part of complete and solid urethane construction from the hand-grip fastener at their base to the top-end of the spherical head-knob tips. Other options of material composition of the tool heads may be other firm, scratch resistant, impact resistant materials.

The elongated extension-pole-control-handle is comprised of a stout, solid or hollow, impact-resistant fiberglass or thermoplastic material or equivalent and has a hand-grip tool-end fastener. Any suitable means of secure, streamlined fastening can be used. Note: The “elongated extension-pole-control-handle” is not claimed by the inventor to be an invention of his own, but is only described in these documents as reference to the elongated extension-pole-control-handle as being a significant, necessary, integral part of the present invention's system, design, function and operation.

With reference now to the drawings and in particular to FIG. 1-A through FIG. 3-A: a new massage, gentling, grooming, tactile diagnostic tool embodying the principles and concepts of the present invention and generally designated by the references to tool-head-attachment-A and tool-head-attachment-B and the elongated extension-pole control handle.

Tool-head-attachment-A, FIG. 1-A: The entire main body comprises a solid, streamlined, circumferentially circular, nodular cylindrical shaft, comprising of a hand-grip-fastener at its base (9) which is directly connected to a lengthily inline series of independent, spherical nodules in a single row (3) that form the said main body positioned in succession at equal intervals (4) between one another so that the said spherical nodules are just in contact with each other. The said intervals provide horizontally narrow sections (4) or dips of the said series. The physical transitions between the said nodules and said intervals bond curvedly in a complete symmetrical sloping curvature fashion (4). The diameter of the said intervals (4) is generally one half the diameters of the said nodules. The said spherical nodules are positioned along generally four-fifths the length of the main body and connect curvedly and sloping to the slightly narrower, slightly elongated curved inset named as the “gauging neck” (5) which is curvedly connected to the enlarged spherical head-knob or tip. Tool-head-attachment-A FIG. 1-A uses are for massage, gentling, and diagnostic assessments and evaluations. Several techniques are performed when using tool-head-attachment-A on the animal or human body: stroking in a back-and-forth motion, stroking in a zigzag back-and-forth motion, stroking in a lateral motion, stroking in a circular motion and also by applying direct inline pressure to the tip of the tool against the subject's body which can be also described as acupressure or reflexology.

The present invention provides an auto-mechanical vibration massage that is produced when in use via a lengthwise back and forth or reciprocating motion. To be more specific, as the succession of said series of nodules (3) are pressed against and over a body part, most particularly smaller protruding body parts, the impact of the said series of nodules (3) in rapid succession emit physical shockwaves that penetrate the muscles and body tissue that are pleasantly stimulating, relaxing, and soothing to the subject's body. Faster length-wise reciprocating motion will emit more intense shockwave value or vibration; adversely slower reciprocating motions will emit milder shockwave values; in respect, less or more pressure applied to the body also has an effect on the shockwave intensity, hence the term “auto-mechanical vibration”.

The “pulling-nook”(7) where the circumference of the spherical head and gauging neck meet (7) provides an angle or curve that allows the user to be able to pull on small protruding curvatures of the animal or humans body when massaging, gentling, or performing tactile examinations. The curved inset of said gauging-neck (5) and (6) provides a means to see and feel when the tool has come to its end when being used with reciprocating motions. This said curved inset also helps to avoid rubbing said tool-head against bone, particularly the spine.

Tool-head-attachment-B, FIG. 2-A: The entire main body comprises a solid, streamlined, circumferentially-circular, cylindrical, cone-spike covered shaft, which comprises a hand-grip-fastener handle at its base (9) which is directly and curvedly connected to the said cylindrical, cone-spike covered shaft. The said shaft comprises a pattern of in-row or staggered-rowed cone-shaped spikes (8) in a series of staggered rows or patterns which cover the entire surface area (8) of the said tool-head-attachment that extend generally ⅘ths the length of the said spiked, cylindrical shaft and connect curvedly to the slightly narrower, slightly elongated, curved inset named as the spiked gauging neck (6) which is curvedly connected to the enlarged, spiked, spherical head-knob (2). The said cone-shaped spikes (8) and (12) are positioned as close as possible to each other to provide a less irritating, more comfortable surface area to the touch, i.e. the abundance of the said spikes and their close proximity to one another (8) and (12) simulate an abrasive yet non-intrusive texture. The tips of the said cone-shaped spikes (12) are sharp enough and firm enough so as to spread apart the animal's fur coat and exfoliate skin and dander much in the fashion as a comb or brush, yet the tips of the said cone-shaped spikes are blunt enough to exfoliate the skin without puncturing or cutting into the skin. The said hand-grip-fastener (9) provides secure fastening to the said elongated, extension-pole-control-handle. Tool-head-attachment-B FIG. 2-A uses are for massaging and gentling, exfoliating, grooming: brush/combing/exfoliating and tactile diagnoses. Several techniques are performed when using the tool on an animal body: stroking in a back-and-forth motion, stroking in a zigzag back-and-forth motion, stroking in a side-to-side motion, stroking in a circular motion, turning or twisting motion and scratching or itching motion. The said “pulling-nook”(7) where the circumference of the said spiked, spherical head-knob (2) and said gauging neck meet (6) provides a angle or curve that allows the user to be able to pull on small protruding curvatures of the animal body when massaging, gentling, grooming or performing tactile examinations. The curved inset of said gauging-neck (5) and (6) provides a means to see and feel when the tool has come to its end when being used with reciprocating motions. This said curved inset also helps to avoid rubbing said tool-head against bone, particularly the spine.

To better understand the present invention's form and to help better understand its dynamics of usability, general dimensions are set forth as follows. The general length of both tool-head-attachments-A and -B is 23 inches from the top of the said spherical head-knob to the bottom of the said hand grip fastener. The general length of the said extension-pole-control-handle is 43 inches with a combined length of generally 66 inches when securely fastened to either one of the tool-head-attachments.

What is claimed is:

1. What is claimed is a method and streamlined apparatus specific to gentle and bond the equine, humans, and other animals by means of body massage, pole-gentling, grooming, and tactile diagnosis, provided by a tool-system comprised of three main components in which the first component is comprised of an elongated extension-pole-handle that of which is considered the main user operating-control-handle of that which also exhibits an adaptor fastening-port for the two individual working-end tool-head attachments to securely fasten to said extension-pole-control-handle, each of which is comprised of a solid molded form comprised of a plastics, rubberized plastics, porcelain material or the equivalent in which the second component comprises an elongated cylindrical nodulated animal/human massage/gentling tool-head attachment and the third component that of which the main body is comprised of a cone-shape-spike-covered cylindrical animal groomer/exfoliator tool-head shaft of which all of these said three main components will be made more evident through descriptions and explanations when considered with any former or prior claims herein.

2. What is claimed here is in direct and exact relation, cooperation, and correspondence to claim one and any claims that follow, is that of a method and streamlined apparatus for gentling, calming, and bonding of an equine species, humans, and other animals accomplished by means and actions of body massage, caressing, vibrational body stimulus which is comprised of solid molded part comprising an elongated cylindrical main body that comprises a base-end fastener or connector-end, inline and solidly affixed thereof to an inline series of equally proportionate and equally spaced series of inline massage nodules that of which is solidly affixed thereof to a narrower gauging neck or stem that of which is inline and solidly affixed thereof to a slightly enlarged spherical knob tip or end, which when in use and manually operated over a human or animal's body in a reciprocating back-and-forth motion, the said nodules lightly bounce on and off the body surface of the subject animal or human, causes auto-mechanical vibrations that of which are soothing, calming, relaxing and which mimic or simulate the feel, impression, or touch of a mother mare licking and nudging her newborn foal; that of which is also soothing, comforting, muscle-relaxing, to the animal and human as well, in which all said descriptions and explanations will become more evident when considered with any former or prior claims herein.

3. What is claimed here is in direct and exact relation, cooperation, and correspondence to claim one and claim two, that of which is a method and streamlined apparatus for gentling, grooming, and bonding of an equine species and other animals species accomplished by means and actions of grooming, brushing, scrubbing, exfoliating, and massage by means of this third component exfoliator massage tool-head attachment that of which is comprised of a solid elongated cylindrical-mold main body comprised of a base-end hand-grip fastener, inline and solidly affixed to the cylindrical main body that of which is solidly affixed to the gauging neck or stem that of which is solidly affixed to the enlarged spherical knob tip or end in which generally the entire said cylindrical-mold main body is covered with inline or staggered-line patterns of protruding cone-shaped-spike bristles or nubs; all of which when in use and considered with claims one and two herein is operated, controlled, and administered in use by gentle caressing, scrubbing, brushing, rolling and scratching motion that provides a calming, soothing, body stimulus which creates animal-human mutual trust and respect, animal-leg-handling and touch acclimation, while also providing and improving on the animal's physical and mental health and overall animal and human well being.
